(19) United States
(12) Patent Application Publication
(10) Pub. No.: US 2025/0030370 A1
(43) Pub. Date: Jan. 23, 2025

(54) HEAT PUMP APPARATUS, AIR CONDITIONER, AND REFRIGERATION MACHINE

(71) Applicant: Mitsubishi Electric Corporation, Tokyo (JP)

(72) Inventors: Yuichi SHIMIZU, Tokyo (JP); Kazunori HATAKEYAMA, Tokyo (JP)

(21) Appl. No.: 18/712,832

(22) PCT Filed: Jan. 31, 2022
(86) PCT No.: PCT/JP2022/003581

§ 371 Date: May 23, 2024

(51) Int. Cl. H02P 27/08; F25B 31/02

(52) U.S. Cl. CPC H02P 27/085; F25B 31/026

(57) ABSTRACT

A heat pump apparatus includes: an inverter that applies a high-frequency voltage to a motor that drives a compressor, the high-frequency voltage having a frequency higher than or equal to an operation frequency of the compressor; and an inverter controller that switches between positive and negative directions of an output voltage output from the inverter every half period of a carrier signal, the carrier signal being used for generating a switching signal, the switching signal controlling whether each of the switching elements is on or off. The inverter controller prohibits switching between positive and negative directions of the output voltage in a first time period, the first time period being a time period of an integer multiple of two or more times the half period of the carrier signal.

### FIELD

The present disclosure relates to a heat pump apparatus including a compressor, an air conditioner, and a refrigeration machine.

### BACKGROUND

A device including a compressor that compresses a refrigerant has a function with which, in order to prevent the compressor from being damaged by starting an operation when the refrigerant remaining in the compressor is in a state of stagnation, a current is caused to flow through a winding of a motor of the compressor to heat the refrigerant when the refrigerant is brought into the state of stagnation. An example of the device including a compressor is a heat pump apparatus. The heat pump apparatus is applied to an air conditioner, a heat pump water heater, a refrigerator, or a refrigeration machine of a freezer or the like.

In the air conditioner described in Patent Literature 1, in a case where a stagnation state of a refrigerant is detected, a high-frequency voltage having a frequency higher than that when performing an operation of compressing the refrigerant is applied to a motor, thereby preventing generation of rotational torque and vibration, and realizing efficient heating using iron loss and copper loss.

### CITATION LIST

### Patent Literature

Patent Literature 1: Japanese Patent Application Laid-open No. 2011-38689

### SUMMARY OF INVENTION

### Problem to be Solved by the Invention

In the conventional technique represented by Patent Literature 1, it is assumed that an insulated gate bipolar transistor (IGBT) is used as a switching element included in an inverter. When a general IGBT is used, an upper limit of a carrier frequency is about 20 kHz. However, when a SiC device using silicon carbide, a GaN device using gallium nitride, or the like is used, a carrier frequency up to several tens of kHz to several hundreds of kHz can be used. Therefore, when such a SiC device or GaN device is used, a frequency spectrum can be spread in a wider range by increasing the carrier frequency, and a further noise reduction effect can be expected.

However, in the technique described in Patent Literature 1, each of the switching elements performs a switching operation one or more times in one period of a carrier signal, and therefore, when the carrier frequency is increased, switching loss increases, the efficiency of the heat pump apparatus deteriorates, and the cost for heat dissipation of the inverter increases, which is problematic. In addition, since the carrier frequency of the inverter and a motor torque fluctuation frequency generated by the high-frequency voltage output from the inverter are identical with each other, the noise spectra thereof are likely to overlap, and noise may be increased.

The present disclosure has been made in view of the above, and an object thereof is to provide a heat pump apparatus capable of reducing deterioration in efficiency and an increase in noise even when a carrier frequency is increased.

### Means to Solve the Problem

In order to solve the above problem and achieve the object, a heat pump apparatus according to the present disclosure includes an inverter including a plurality of switching elements and applying a high-frequency voltage to a motor that drives a compressor, the high-frequency voltage having a frequency higher than or equal to an operation frequency of the compressor. In addition, the heat pump apparatus includes an inverter controller switching between positive and negative directions of an output voltage output from the inverter every half period of a carrier signal, the carrier signal being used for generating a switching signal, the switching signal controlling whether each of the switching elements is on or off. The inverter controller prohibits switching between positive and negative directions of the output voltage in a first time period, the first time period being a time period of an integer multiple of two or more times the half period of the carrier signal.

### Effects of the Invention

The heat pump apparatus according to the present disclosure achieves an effect that it is possible to reduce deterioration in efficiency and an increase in noise even when a carrier frequency is increased.

### BRIEF DESCRIPTION OF DRAWINGS

FIG. 1 is a diagram illustrating an example configuration of a heat pump apparatus according to a first embodiment.

FIG. 2 is a diagram illustrating an example of a hardware configuration that realizes an inverter controller included in the heat pump apparatus according to the first embodiment.

FIG. 3 is a diagram illustrating an example of a detailed configuration of a main part of the heat pump apparatus according to the first embodiment.

FIG. 4 is an operation waveform diagram for explaining a basic operation of the heat pump apparatus according to the first embodiment in a heating operation mode.

FIG. 5 is a flowchart for explaining the basic operation of the heat pump apparatus according to the first embodiment in the heating operation mode.

FIG. 6 is a diagram for explaining voltage vectors when the heat pump apparatus according to the first embodiment operates in accordance with the flowchart illustrated in FIG. 5.

FIG. 7 is a flowchart for explaining an improved operation of the heat pump apparatus according to the first embodiment in the heating operation mode.

FIG. 8 is an operation waveform diagram for explaining the improved operation of the heat pump apparatus according to the first embodiment in the heating operation mode.

FIG. 9 is a diagram illustrating an example of a detailed configuration of a main part of a heat pump apparatus according to a second embodiment.

FIG. 10 is an operation waveform diagram for explaining an operation of the heat pump apparatus according to the second embodiment in a heating operation mode.

FIG. 11 is a diagram illustrating an example of a detailed configuration of a main part of a heat pump apparatus according to a third embodiment.

### DESCRIPTION OF EMBODIMENTS

Hereinafter, a heat pump apparatus, an air conditioner, and a refrigeration machine according to each embodiment of the present disclosure will be described in detail with reference to the accompanying drawings. Note that the embodiments described below are illustrative, and the scope of the present disclosure is not limited by the embodiments described below.

### First Embodiment

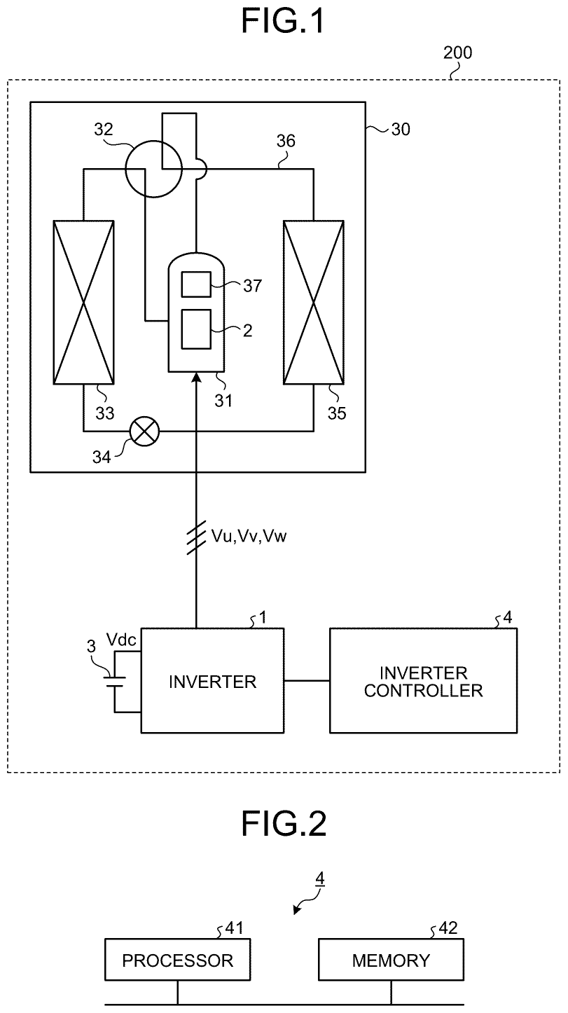

FIG. 1 is a diagram illustrating an example configuration of a heat pump apparatus 200 according to a first embodiment. FIG. 2 is a diagram illustrating an example of a hardware configuration that realizes an inverter controller 4 included in the heat pump apparatus 200 according to the first embodiment.

The heat pump apparatus 200 according to the first embodiment includes a refrigeration cycle 30 in which a compressor 31, a four-way valve 32, a heat exchanger 33, an expansion mechanism 34, and a heat exchanger 35 are sequentially connected through a refrigerant pipe 36. The compressor 31 includes a compression mechanism 37 and a motor 2. The compression mechanism 37 is a drive mechanism for compressing a refrigerant flowing through the interior of the refrigerant pipe 36. The motor 2 is a drive motor that drives the compressor 31. An example of the motor 2 is a three-phase motor including windings of three phases, i.e., a U phase, a V phase, and a W phase.

The inverter 1 is electrically connected to the motor 2 and a direct-current power supply 3. The direct-current power supply 3 is a drive source of alternating-current power to be supplied to the motor 2. The inverter 1 converts a direct-current voltage Vdc output from the direct-current power supply 3 into alternating-current voltages Vu, Vv, and Vw of respective phases to the motor 2, and performs application thereof to the windings of respective phases (not illustrated) of the motor 2. The inverter controller 4 is electrically connected to the inverter 1. The inverter controller 4 generates a drive signal for driving the inverter 1 and outputs the drive signal to the inverter 1. An example of the drive signal is a pulse width modulation (PWM) signal.

The inverter controller 4 controls an operation of the inverter 1 in accordance with two operation modes of a normal operation mode and a heating operation mode. For operation in the normal operation mode, the inverter controller 4 controls the inverter 1 so that the motor 2 is rotationally driven. For operating in the heating operation mode, the inverter controller 4 controls the inverter 1 so that the compressor 31 is heated without rotational driving of the motor 2. In the heating operation mode, the inverter 1 applies, to the motor 2, a high-frequency voltage having a frequency higher than or equal to an operation frequency of the compressor 31. In addition, in this heating operation mode, a high-frequency current that the motor 2 cannot follow flows through the motor 2. At that time, iron loss and copper loss are generated in the motor 2. Consequently, it is possible to heat the motor 2 without rotationally driving the motor 2. In addition, when the motor 2 is heated, a liquid refrigerant remaining in the compressor 31 is warmed and vaporized. Consequently, the liquid refrigerant remaining in the compressor 31 is discharged outside.

A function of the inverter controller 4 can be implemented by a processor 41 and a memory 42 as illustrated in FIG. 2. The processor 41 is a processing means called a central processing unit (CPU), a central processing device, a processing device, an arithmetic device, a microprocessor, a microcomputer, a microcontroller, a digital signal processor (DSP), or system large scale integration (LSI). As the memory 42, a nonvolatile or volatile semiconductor memory such as a random access memory (RAN), a read only memory (ROM), a flash memory, an erasable programmable read only memory (EPROM), or an electrically erasable programmable read only memory (EEPROM (registered trademark)) can be exemplified. Note that the memory 42 is not limited thereto, and may be a magnetic disk, an optical disk, a compact disc, a mini disk, or a digital versatile disc (DVD).

The memory 42 stores a program for executing control by the inverter controller 4. The processor 41 reads and executes the program stored in the memory 42, thereby performing the operations in the normal operation mode and the heating operation mode described above. A result of calculation by the processor 41 can be stored in the memory 42.

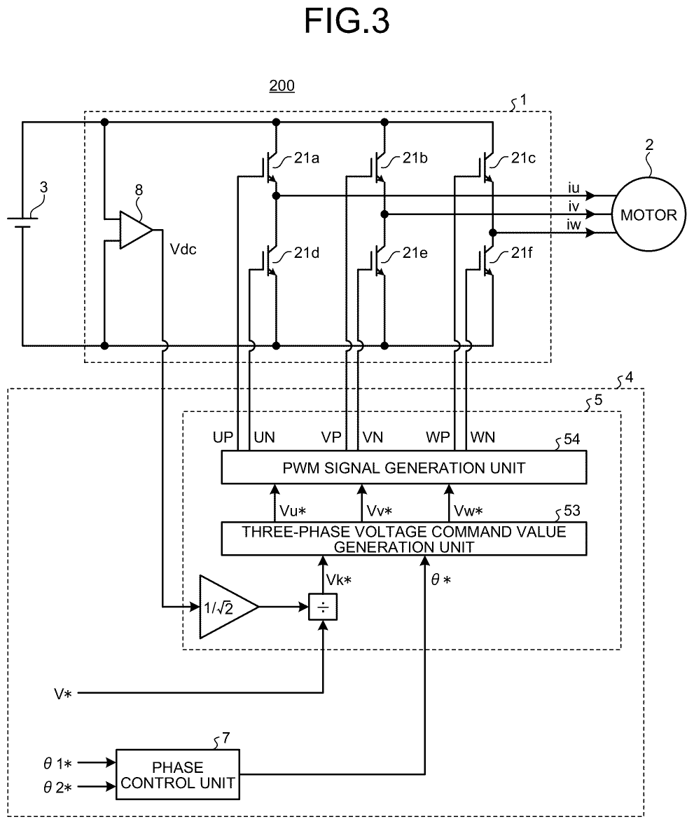

FIG. 3 is a diagram illustrating an example of a detailed configuration of a main part of the heat pump apparatus 200 according to the first embodiment. FIG. 3 illustrates specific example configurations of the inverter 1 and the inverter controller 4.

The inverter 1 includes a plurality of switching elements. As the switching elements, the illustrated IGBTs are exemplified, but not limited thereto. The switching elements may be metal oxide semiconductor field effect transistors (MOSFETs). In order to reduce a surge voltage due to switching operations of the switching elements, freewheeling diodes (not illustrated) may be connected in parallel to the switching elements. Regarding the freewheeling diodes, parasitic diodes of the switching elements may be used. Note that in the case of the MOSFETs, a similar freewheeling operation may be realized by turning on the switching elements at timing of freewheeling of a current through the switching elements without using the parasitic diodes.

In addition, as a material constituting the switching elements, not only silicon (Si) but also silicon carbide (SiC), gallium nitride (GaN), gallium oxide (Ga₂O₃), diamond, or the like, which is a wide bandgap semiconductor, may be used. That is, the switching elements may be formed of a wide band gap semiconductor.

When the motor 2 is a three-phase motor, as illustrated in FIG. 3, the inverter 1 includes six switching elements 21a to 21f. The switching elements 21a and 21d are connected in series to constitute a U-phase leg, the switching elements 21b and 21e are connected in series to constitute a V-phase leg, and the switching elements 21c and 21f are connected in series to constitute a W-phase leg. These three legs, that is, the U-phase, V-phase, and W-phase legs are connected in parallel to one another to constitute a three-phase inverter circuit.

Note that, regarding the switching elements constituting the three-phase inverter circuit, each of the switching elements 21a to 21c may be referred herein to as an “upper switching element”, and each of the switching elements 21d to 21f may be referred herein to as a “lower switching element”. In addition, a set of switching elements 21a to 21c may be referred to as an “upper switching element group”, and a set of switching elements 21d to 21f may be referred to as a “lower switching element group”.

The inverter 1 further includes a voltage detector 8. The voltage detector 8 detects the direct-current voltage Vdc output from the direct-current power supply 3 and outputs the detected value to the inverter controller 4.

The inverter controller 4 includes a drive signal generation unit 5 and a phase control unit 7. The drive signal generation unit 5 includes a three-phase voltage command value generation unit 53 and a PWM signal generation unit 54.

The direct-current voltage Vdc and a voltage amplitude command value V* are input to the drive signal generation unit 5. The drive signal generation unit 5 generates a voltage modulation rate command value Vk* on the basis of the direct-current voltage Vdc and the voltage amplitude command value V*, and outputs the voltage modulation rate command value Vk* to the three-phase voltage command value generation unit 53. Specifically, the voltage modulation rate command value Vk* is calculated in accordance with the following formula (1).

Vk*=V*×√2/Vdc (1)

A first voltage phase θ1* and a second voltage phase θ2* are input to the phase control unit 7. The first voltage phase θ1* and the second voltage phase θ2* are setting values or signals having a phase difference of 180° from each other. The phase difference may not be strictly 180°. In FIG. 3, the first voltage phase θ1* and the second voltage phase θ2* are illustrated to be set inside the inverter controller 4, but may be input from the outside of the inverter controller 4.

The phase control unit 7 generates a voltage phase command value θ* on the basis of the first voltage phase θ1* and the second voltage phase θ2*, and outputs the voltage phase command value θ* to the three-phase voltage command value generation unit 53. The detailed operation of the phase control unit 7 and details of a method for generating the voltage phase command value θ* will be described later.

The three-phase voltage command value generation unit 53 generates three-phase voltage command values Vu*, Vv*, and Vw* on the basis of the voltage modulation rate command value Vk* and the voltage phase command value θ*. The PWM signal generation unit 54 generates PWM signals UP, UN, VP, VN, WP, and WN on the basis of the three-phase voltage command values Vu*, Vv*, and Vw*. The PWM signals UP and UN are switching signals for respectively controlling whether the switching elements 21a and 21d of the U-phase leg are on or off. Similarly, the PWM signals VP and VN are switching signals for respectively controlling whether the switching elements 21b and 21e of the V-phase leg are on or off, and the PWM signals WP and WN are switching signals for respectively controlling whether the switching elements 21c and 21f of the W-phase leg are on or off. A carrier signal to be described later is used to generate these switching signals. Note that the PWM signals UP, UN, VP, VN, WP, and WN can also be generated without using the carrier signal, for example, by referring to table data stored in the memory 42.

By the above-described control, three-phase alternating-current voltages Vu, Vv, and Vw are applied to the motor 2. In addition, the three-phase alternating-current voltages Vu, Vv, and Vw cause a U-phase current iu, a V-phase current iv, and a W-phase current iw, which are three-phase alternating-currents, to flow between the inverter 1 and the motor 2.

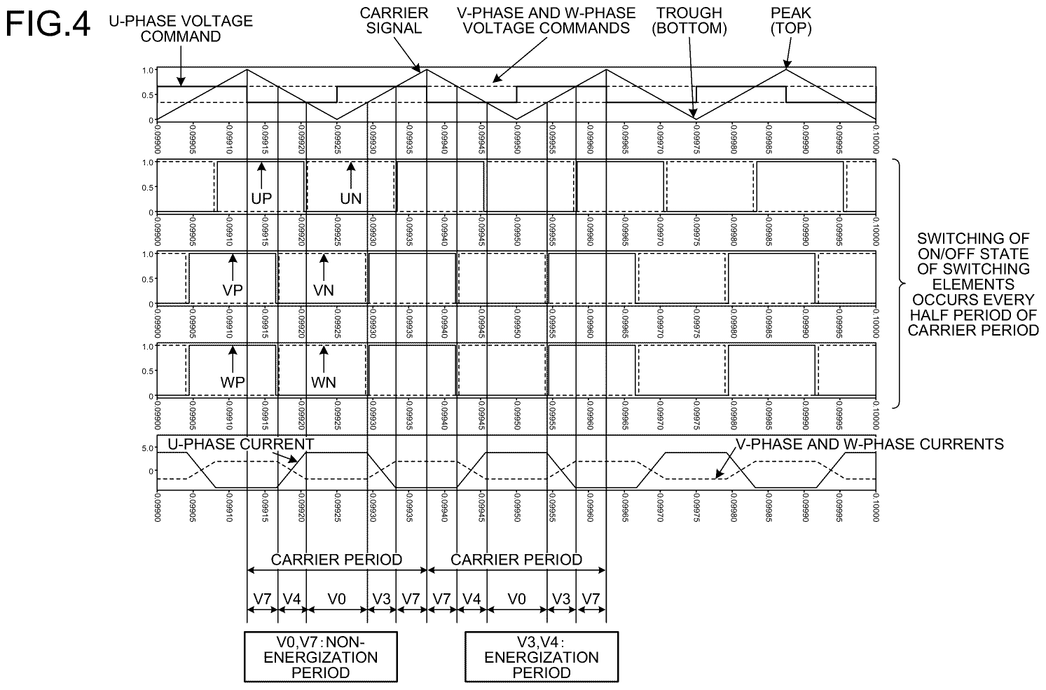

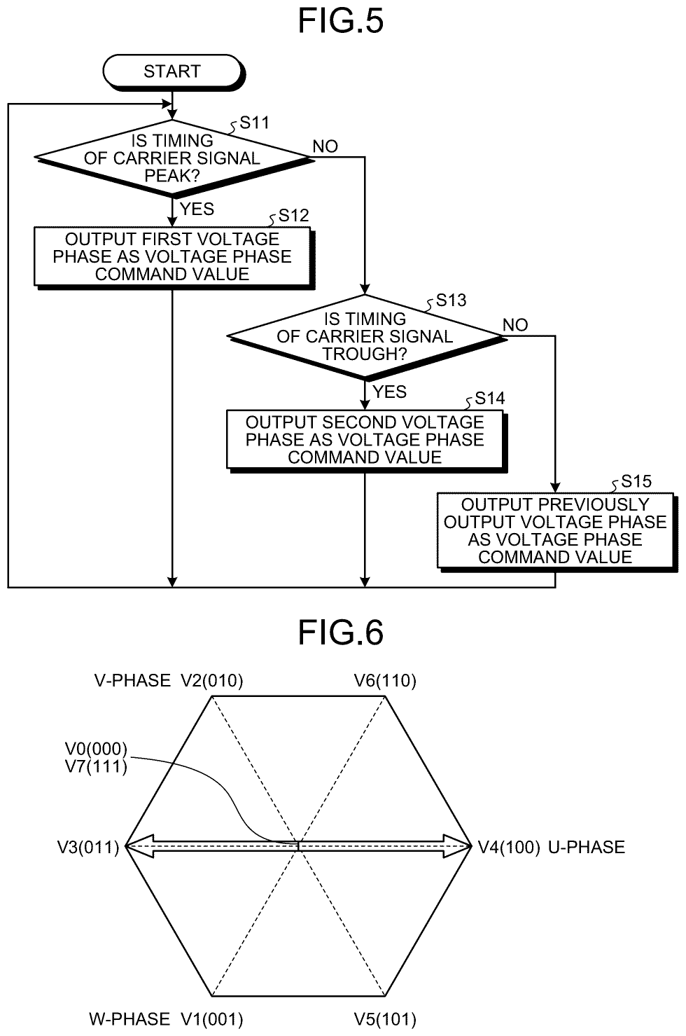

Next, a basic operation of the heat pump apparatus 200 according to the first embodiment in a heating operation mode will be described with reference to FIGS. 4 to 6. FIG. 4 is an operation waveform diagram for explaining the basic operation of the heat pump apparatus 200 according to the first embodiment in the heating operation mode. FIG. 5 is a flowchart for explaining the basic operation of the heat pump apparatus 200 according to the first embodiment in the heating operation mode. FIG. 6 is a diagram for explaining voltage vectors when the heat pump apparatus 200 according to the first embodiment operates in accordance with the flowchart illustrated in FIG. 5.

First, waveforms in FIG. 4 will be described. In a first row in FIG. 4, the carrier signal is indicated by a solid line, the U-phase voltage command value Vu* is indicated by a thick solid line, and the V-phase voltage command value Vv* and the W-phase voltage command value Vw* are indicated by a broken line. The V-phase voltage command value Vv* and the W-phase voltage command value Vw* change at the same timing. In a second row in FIG. 4, the PWM signal UP is indicated by a solid line, and the PWM signal UN is indicated by a broken line. In a third row in FIG. 4, the PWM signal VP is indicated by a solid line, and the PWM signal VN is indicated by a broken line. In a fourth row in FIG. 4, the PWM signal WP is indicated by a solid line, and the PWM signal WN is indicated by a broken line. In a fifth row in FIG. 4, the U-phase current iu is indicated by a solid line, and the V-phase current iv and the W-phase current iw are indicated by a broken line.

In the first row in FIG. 4, phases of the U-phase voltage command value Vu*, the V-phase voltage command value Vv*, and the W-phase voltage command value Vw* are switched at timings of peaks and troughs of the carrier signal. This means that, in FIG. 3, the first voltage phase θ1* and the second voltage phase θ2* are switched and output as the voltage phase command value θ* output from the phase control unit 7 to the three-phase voltage command value generation unit 53.

FIG. 6 illustrates eight voltage vectors V0 to V7 determined by a combination of the PWM signals UP, VP, and WP. The numerical values in parentheses represent the voltage levels of the PWM signals UP, VP, and WP in order from the left. Note that, regarding pairs of the PWM signal UP and the PWM signal UN, the PWM signal VP and the PWM signal VN, and the PWM signal WP and the PWM signal WN, corresponding pairs of switching elements in each leg exhibit on/off relationships opposite to each other, and thus when one of them is known, then the other is also known. Therefore, the description of the PWM signals UN, VN, and WN is omitted. The voltage vectors V0 and V7 are zero vectors in which no voltage is generated.

The flowchart of FIG. 5 illustrates the basic operation of the phase control unit 7 in the heating operation mode. First, the phase control unit 7 determines whether a timing of the carrier signal is peak, that is, the top of the carrier signal (step S11). If the timing of the carrier signal is peak (step S11, Yes), the phase control unit 7 outputs the first voltage phase θ1* as the voltage phase command value θ* (step S12). Thereafter, the process returns to step S11, and processes in accordance with the process flow of FIG. 5 are repeated.

If the timing of the carrier signal is not peak (step S11, No), the phase control unit 7 determines whether the timing of the carrier signal is trough, that is, the bottom of the carrier signal (step S13). If the timing of the carrier signal is trough (step S13, Yes), the phase control unit 7 outputs the second voltage phase θ2* as the voltage phase command value θ* (step S14). Thereafter, the process returns to step S11, and processes in accordance with the process flow of FIG. 5 are repeated.

If the timing of the carrier signal is not trough (step S13, No), the phase control unit 7 outputs the previously output voltage phase as the voltage phase command value θ* (step S15). Thereafter, the process returns to step S11, and processes in accordance with the process flow of FIG. 5 are repeated.

The operation at that time is illustrated in FIG. 4. In FIG. 4, with the peak of the carrier signal as a start point and from a viewpoint of a carrier period which is one period of the carrier signal, the voltage vectors change in the order of V7 (UP=VP=WP=1), V4 (UP=1, VP=WP=0), V0 (UP=VP=WP=0), V3 (UP=0, VP=WP=1), and V7 (UP=VP=WP=1). A similar change occurs in the next carrier period.

The voltage vector V7 is a period in which entirety of the upper switching element group of the inverter 1 are controlled to be on and entirety of the lower switching element group of the inverter 1 are controlled to be off. Therefore, when in the switching pattern of the voltage vector V7, no current flows through the motor 2, and an inverter current flowing through the inverter 1 freewheels the interior of the inverter 1. In addition, the voltage vector V0 is a period in which entirety of the upper switching element group are controlled to be off and entirety of the lower switching element group of the inverter 1 are controlled to be on. Therefore, even when in the switching pattern of the voltage vector V0, the inverter current freewheels the interior of the inverter 1. On the contrary, when in a switching pattern other than those of the voltage vectors V0 and V7, a voltage applied to the motor 2 is generated, and the inverter current flows through the motor 2. On the other hand, as illustrated in FIG. 6, the voltage vector V4 and the voltage vector V3 are vectors having phases different from each other by 180°. Switching between positive and negative directions of the output voltage output from the inverter 1 is performed by the voltage vectors V3 and V4. A period when the switching pattern is that of the voltage vector V0 or V7 may be referred herein to as a “non-energization period”, and a period when the switching pattern is other than those of the voltage vectors V0 and V7 may be referred herein to as an “energization period”. In order to distinguish between these two non-energization periods, the period when the switching pattern is that of the voltage vector V7 may be referred to as a “first non-energization period”, and the period when the switching pattern is that of the voltage vector V0 may be referred to as a “second non-energization period”.

Note that, in FIG. 4, switching patterns of the voltage vectors V3 and V4 are exemplified as the switching pattern for switching between positive and negative directions of the output voltage output from the inverter 1, but there is no limitation to the example. A combination of the voltage vectors V1 and V6 or the voltage vectors V2 and V5 having a phase difference of 1800 may be used. In addition, the direction of the output voltage is not necessarily any of the directions of the voltage vectors V1 to V6, and may be a combination of voltage vectors in any directions having a phase difference of 180°.

As described above, the inverter controller 4 included in the heat pump apparatus 200 according to the first embodiment switches between positive and negative directions of the output voltage output from the inverter 1 every half period of the carrier period which is one period of the carrier signal. When performing this control, if a switching frequency which is the frequency of the PWM signal is changed with the lapse of time, the frequency of the output voltage also changes. With this control, a frequency spectrum of a motor current flowing through the motor 2 can be spread. Consequently, high-frequency noise during heating of the compressor 31 can be reduced, and a leakage current that can occur due to remaining of the refrigerant which is a dielectric can be reduced.

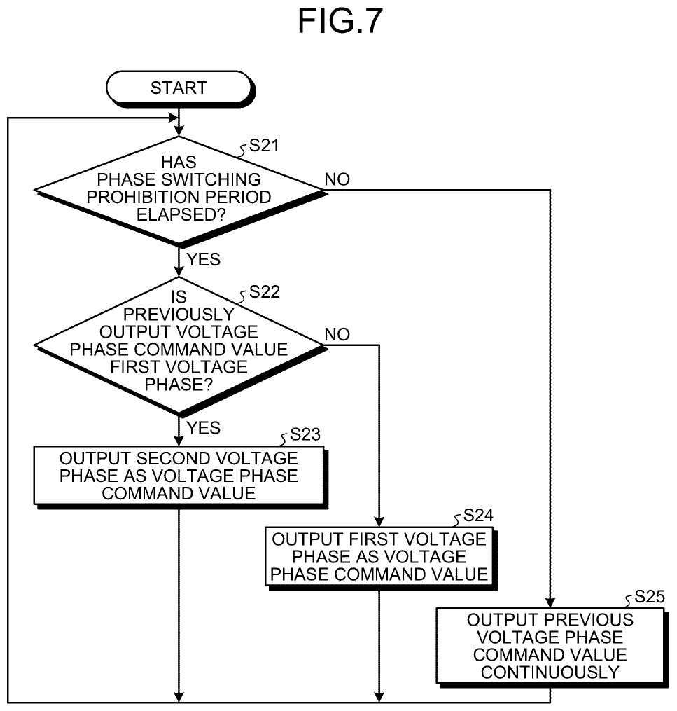

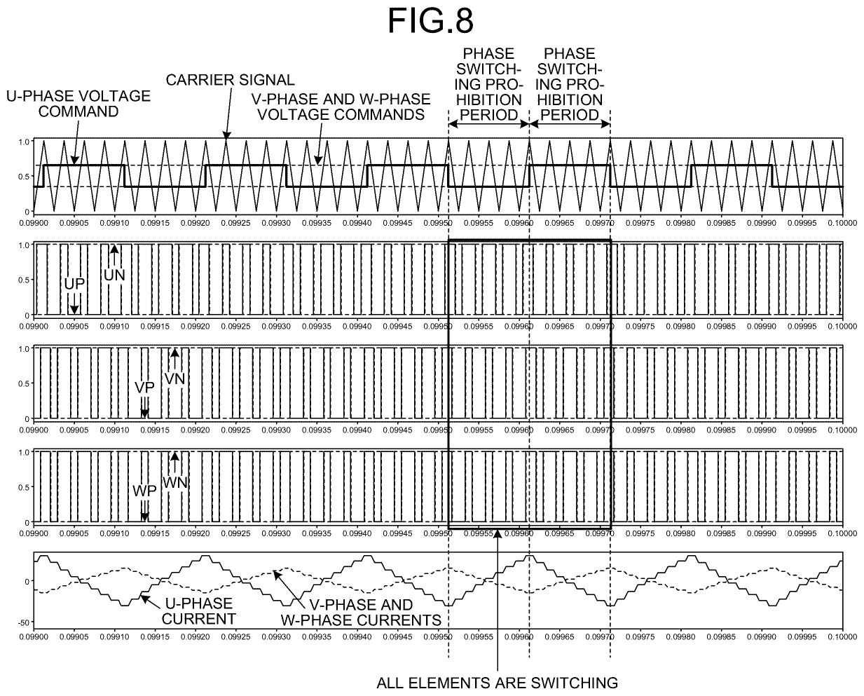

By the way, as also illustrated in FIG. 4, switching of the on/off state of the switching elements occurs every half period of the carrier period in the switching patterns of FIG. 4. In a case of a general IGBT in which the upper limit of the carrier frequency is about 20 kHz, an increase in switching loss does not cause a major problem. On the other hand, in a case where the switching element is formed of a wide band gap semiconductor, when the carrier frequency is increased to several tens kHz to several hundreds kHz by taking advantage of the characteristics of the wide band gap semiconductor, an increase in switching loss is assumed to cause a major problem. Therefore, in the first embodiment, the voltage phase command value θ* is generated in accordance with a process flow of FIG. 7 obtained by improving the process flow of the phase control unit 7 illustrated in FIG. 5. FIG. 7 is a flowchart for explaining an improved operation of the heat pump apparatus 200 according to the first embodiment in the heating operation mode. FIG. 8 is an operation waveform diagram for explaining the improved operation of the heat pump apparatus 200 according to the first embodiment in the heating operation mode.

First, the process flow of FIG. 7 will be described. The phase control unit 7 determines whether a phase switching prohibition period has elapsed (step S21). The concept of the phase switching prohibition period will be described later. If the phase switching prohibition period has not elapsed (step S21, No), the phase control unit 7 continuously outputs the previous voltage phase command value θ* (step S25). Thereafter, the process returns to step S21, and processes in accordance with the process flow of FIG. 7 are repeated.

If the phase switching prohibition period has elapsed (step S21, Yes), the phase control unit 7 determines whether the previously output voltage phase command value θ* is the first voltage phase θ1* (step S22). If the previously output voltage phase command value θ* is the first voltage phase θ1* (step S22, Yes), the phase control unit 7 outputs the second voltage phase θ2* as the voltage phase command value θ* (step S23). Thereafter, the process returns to step S21, and processes in accordance with the process flow of FIG. 7 are repeated.

If the previously output voltage phase command value θ* is not the first voltage phase θ1* (step S22, No), the phase control unit 7 outputs the first voltage phase θ1* as the voltage phase command value θ* (step S24). Thereafter, the process returns to step S21, and processes in accordance with the process flow of FIG. 7 are repeated.

As described above, the phase control unit 7 continuously outputs the previous voltage phase command value θ* until the phase switching prohibition period elapses, and every time the phase switching prohibition period elapses, the phase control unit 7 switches between the first voltage phase θ1* and the second voltage phase θ2* and performs output thereof. By this control, directions of the voltage vectors change every phase switching prohibition period, so that the frequency of the high-frequency voltage depends on the phase switching prohibition period.

Here, the phase switching prohibition period is represented by “Tdis”, and the frequency of the high-frequency voltage is represented by “Fh”. At that time, the frequency Fh of the high-frequency voltage is expressed by the following formula (2).

Fh=1/(2×Tdis) (2)

In addition, the carrier frequency is represented by “Fc”, and the carrier period is represented by “Tc”. At that time, the carrier period Tc is in a relationship of the following formula (3), and in a case where the phase switching prohibition period Tdis is n times the carrier half period (n is an integer of 1 or more), the phase switching prohibition period Tdis is expressed by the following formula (4).

Fc=1/Tc (3)

Tdis=(Tc/2)×n (4)

By the above formulas (2) to (4), the frequency Fh of the high-frequency voltage is expressed by the following formula (5).

Fh=1/(2×Tdis) =1/(2×(Tc/2)×n) =1/(Tc×n) =Fc/n (5)

In the above formula (5), when n=1, the frequency Fh of the high-frequency voltage and the carrier frequency Fc are equal. The operation in this case is similar to the operation in the conventional technique. On the other hand, in the above formula (5), for example, when n=8, the frequency Fh of the high-frequency voltage is ⅛ with respect to the carrier frequency Fc. Examples of operation waveforms at that time are illustrated in FIG. 8. Details of the operation waveforms illustrated in respective rows in FIG. 8 are the same as those in FIG. 4. A period which is an integral multiple of two or more times the carrier half period may be referred herein to as a “first period”.

Focusing on two periods each indicated as “PHASE SWITCHING PROHIBITION PERIOD” in FIG. 8, these phase switching prohibition periods include four periods of the carrier signal. Therefore, the length of the phase switching prohibition period is eight times the carrier half period. In addition, the phase switching is prohibited within each phase switching prohibition period, and the U-phase voltage command value Vu* and the V-phase and W-phase voltage command values Vv* and Vw* are inverted after transition from the phase switching prohibition period on a left side to the phase switching prohibition period on a right side. Consequently, the periods of the U-phase current iu, and the V-phase and W-phase currents iv and iw are also lengthened, and are eight times those in the case of FIG. 4.

As described above, in a case where a high-frequency voltage having a frequency higher than or equal to the operation frequency of the compressor 31 is applied to the motor 2, the motor 2 does not rotate, but a motor torque applied to the motor 2 fluctuates. When a motor torque fluctuation frequency and the carrier frequency are identical with each other, the noise spectra thereof are likely to overlap, which may increase noise. On the other hand, with the use of the process flow of FIG. 7, it is possible to make the frequency of the high-frequency voltage and the carrier frequency non-identical with each other. Consequently, the spectrum of noise due to the carrier frequency and the spectrum of noise due to the motor torque fluctuation frequency can be separated from each other, so that noise generated in the heat pump apparatus 200 can be reduced.

As described above, the heat pump apparatus according to the first embodiment includes the inverter and the inverter controller. The inverter includes the plurality of switching elements, and applies the high-frequency voltage having a frequency higher than or equal to the operation frequency of the compressor to the motor that drives the compressor. The inverter controller switches between positive and negative directions of the output voltage output from the inverter every half period of the carrier signal. The inverter controller prohibits switching between positive and negative directions of the output voltage in a first time period, the first time period being a time period of an integer multiple of two or more times the half period of the carrier signal. Consequently, it is possible to make the frequency of the high-frequency voltage and the carrier frequency non-identical with each other, so that noise generated in the heat pump apparatus can be more reduced than ever.

Again, the heat pump apparatus according to the first embodiment includes the inverter and the inverter controller. The inverter includes the plurality of switching elements, and applies the high-frequency voltage having a frequency higher than or equal to the operation frequency of the compressor to the motor that drives the compressor. The inverter controller switches between positive and negative directions of the output voltage output from the inverter. In this control, between a first non-energization period in which entirety of the upper switching element group of the inverter are controlled to be on and entirety of the lower switching element group of the inverter are controlled to be off, and a second non-energization period in which entirety of the lower switching element group are controlled to be on and entirety of the upper switching element group are controlled to be off, there are a period in which positive and negative directions of the output voltage are switched therebetween and a period in which positive and negative directions of the output voltage are not switched therebetween. With the use of this control, it is possible to make the frequency of the high-frequency voltage and the carrier frequency non-identical with each other. Consequently, noise generated in the heat pump apparatus can be more reduced than ever.

### Second Embodiment

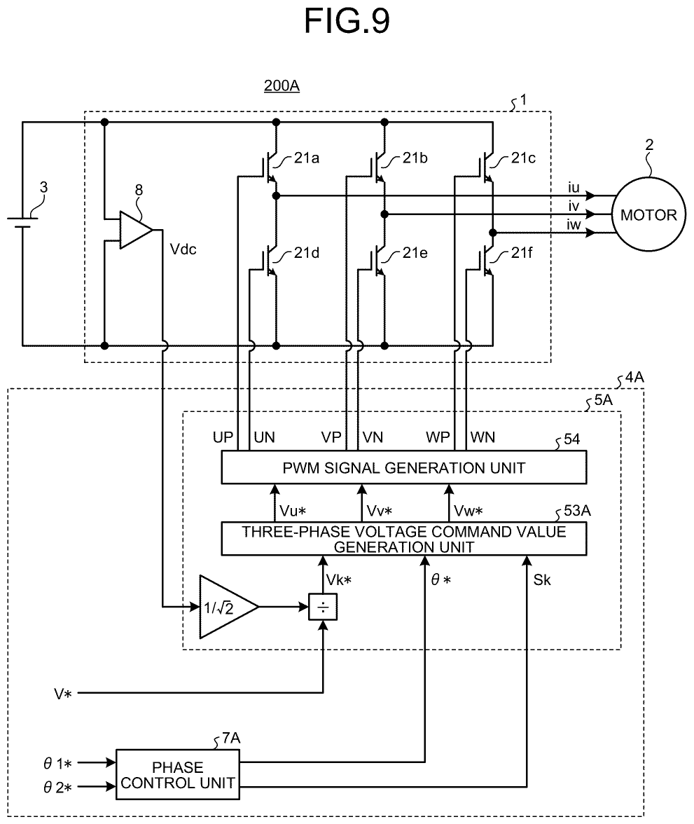

FIG. 9 is a diagram illustrating an example of a detailed configuration of a main part of a heat pump apparatus 200A according to a second embodiment. In FIG. 9, in the heat pump apparatus 200A according to the second embodiment, the inverter controller 4 in the configuration of the heat pump apparatus 200 according to the first embodiment illustrated in FIG. 3 is replaced with an inverter controller 4A. In the inverter controller 4A, the drive signal generation unit 5 is replaced with a drive signal generation unit 5A, and the phase control unit 7 is replaced with a phase control unit 7A. In the drive signal generation unit 5A, the three-phase voltage command value generation unit 53 is replaced with a three-phase voltage command value generation unit 53A. In addition, a configuration is employed in which a phase switching prohibition control execution signal Sk is input from the phase control unit 7A to the three-phase voltage command value generation unit 53A. Other configurations are the same as or equivalent to those in FIG. 3. The same or equivalent components are denoted by the same reference numerals, and repeated descriptions thereof will be omitted.

The three-phase voltage command value generation unit 53A generates three-phase voltage command values Vu*, Vv*, and Vw* on the basis of the voltage modulation rate command value Vk*, the voltage phase command value θ*, and the phase switching prohibition control execution signal Sk. The phase switching prohibition control execution signal Sk is a signal for notifying the three-phase voltage command value generation unit 53A that the control is executed in which the phase switching prohibition period described in the first embodiment is provided. Note that a description will be given assuming that information about the length of the phase switching prohibition period is grasped by the three-phase voltage command value generation unit 53A, but the information may be included in the phase switching prohibition control execution signal Sk to perform a notification thereof to the three-phase voltage command value generation unit 53A.

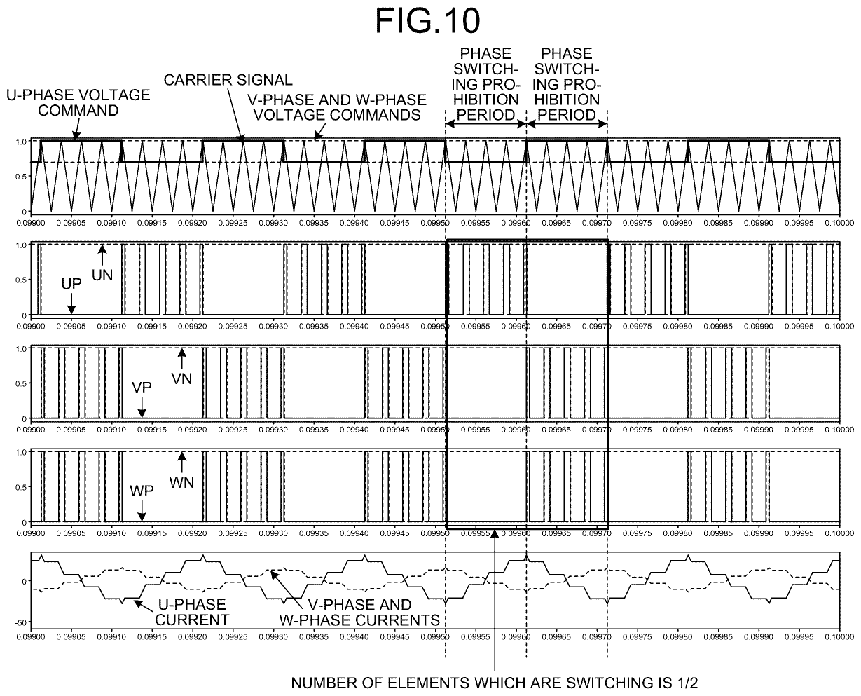

Next, an operation of the heat pump apparatus 200A according to the second embodiment will be described with reference to FIG. 10. FIG. 10 is an operation waveform diagram for explaining an operation of the heat pump apparatus 200A according to the second embodiment in a heating operation mode.

The three-phase voltage command value generation unit 53A that has received the phase switching prohibition control execution signal Sk controls an upper switching element in a leg of one phase or each leg of two phases among the three phases of the inverter 1 to be fixed to on, and controls a lower switching element of a leg to which the upper switching element belongs to be fixed to off in the phase switching prohibition period. Similarly, the three-phase voltage command value generation unit 53A controls an upper switching element in a leg of one phase or each leg of two phases among the three phases of the inverter 1 to be fixed to off, and controls a lower switching element of a leg to which the upper switching element belongs to be fixed to on. In FIG. 10, selection of the phase in which fixing to on or off is performed is realized by using two-phase modulation control in which in a state where line voltage values of the voltage command values of the U phase and the V and W phases are maintained, a predetermined offset is superimposed on each of the voltage command values.

In FIG. 10, in the phase switching prohibition period on the left side of two periods each indicated as “PHASE SWITCHING PROHIBITION PERIOD”, control is performed so that the upper switching elements of the V-phase and W-phase legs are fixed to off and the lower switching elements of the V-phase and W-phase legs are fixed to on. In addition, in the phase switching prohibition period on the right side thereof, control is performed so that the upper switching element of the U-phase leg is fixed to off and the lower switching element of the U-phase leg is fixed to on. Note that the example in FIG. 10 is merely an example, and the relationship between fixing to off and fixing to on may be opposite to that described above. In addition, the two-phase modulation control is merely an example, and other methods other than the two-phase modulation control may be used.

According to the control of the second embodiment, no switching loss occurs in the switching elements fixed to on or off in the legs of respective phases. In addition, comparing FIG. 8 with FIG. 10, while all the elements are switching in FIG. 8, the number of elements which are switching in FIG. 10 is reduced to ½. Therefore, with the use of the control method of the second embodiment, switching loss can be reduced to about ½ as compared with the conventional technique and the first embodiment. Consequently, it is possible to reduce the heat dissipation cost of the inverter 1. In addition, efficiency of the operation of the heat pump apparatus 200A can be improved.

As described above, according to the heat pump apparatus of the second embodiment, in the prohibition period in which the switching between positive and negative directions of the output voltage is prohibited, an upper switching element in a leg of one phase or each leg of two phases among the three phases of the inverter is controlled to be fixed to on or to be fixed to off, and a lower switching element of a leg to which the upper switching element belongs is controlled to be fixed to off or to be fixed to on. Consequently, in addition to the effect of the first embodiment, it is possible to improve the efficiency of the operation of the heat pump apparatus while reducing the heat dissipation cost of the inverter.

According to the control of the second embodiment, no switching loss occurs in the switching elements fixed to on or off in the legs of respective phases. Therefore, with the use of the control method of the second embodiment, switching loss can be reduced to about ½ as compared with the conventional technique and the first embodiment. Consequently, in addition to the effects of the first embodiment, it is possible to improve the efficiency of the operation of the heat pump apparatus 200A while reducing the heat dissipation cost of the inverter 1. In addition, with the use of the control method of the second embodiment, it is possible to reduce an increase in switching loss even in a case where a switching element formed of a wide band gap semiconductor is used.

### Third Embodiment

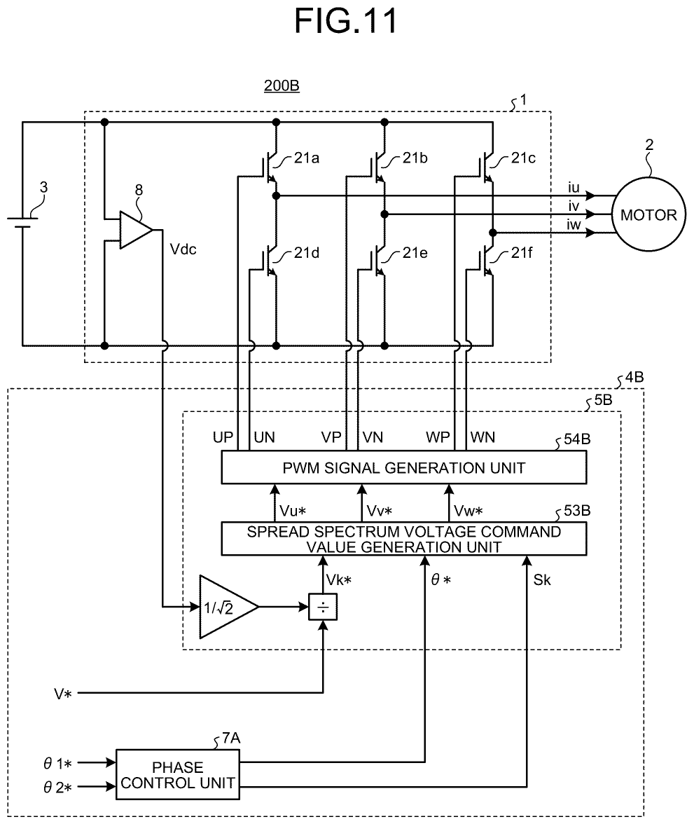

FIG. 11 is a diagram illustrating an example of a detailed configuration of a main part of a heat pump apparatus 200B according to a third embodiment. In FIG. 11, in the heat pump apparatus 200B according to the third embodiment, the inverter controller 4A in the configuration of the heat pump apparatus 200A according to the second embodiment illustrated in FIG. 9 is replaced with an inverter controller 4B. In the inverter controller 4B, the drive signal generation unit 5A is replaced with a drive signal generation unit 5B. In the drive signal generation unit 5B, the three-phase voltage command value generation unit 53A is replaced with a spread spectrum voltage command value generation unit 53B, and the PWM signal generation unit 54 is replaced with a PWM signal generation unit 54B. Other configurations are the same as or equivalent to those in FIG. 9. The same or equivalent components are denoted by the same reference numerals, and repeated descriptions thereof will be omitted.

The spread spectrum voltage command value generation unit 53B has the functions of the three-phase voltage command value generation unit 53 described in the first embodiment and the three-phase voltage command value generation unit 53A described in the second embodiment, and furthermore, has a function of generating the three-phase voltage command values Vu*, Vv*, and Vw* for spreading a frequency spectrum of the high-frequency voltage output from the inverter 1. The three-phase voltage command values Vu*, Vv*, and Vw* for spreading the frequency spectrum can be realized, for example, by changing a ratio between the voltage vector V0 and the voltage vector V7 which are zero vectors. The PWM signal generation unit 54B has a function of generating PWM signals UP, UN, VP, VN, WP, and WN for spreading the frequency spectrum of the high-frequency voltage on the basis of the three-phase voltage command values Vu*, Vv*, and Vw* generated by the spread spectrum voltage command value generation unit 53B. The PWM signals UP, UN, VP, VN, WP, and WN for spreading the frequency spectrum can be realized, for example, by varying the frequency of the carrier signal. By varying the frequency of the carrier signal, the period of the current of each phase can be lengthened or shortened, so that the frequency of the current of each phase can be changed with the lapse of time. In the case of this method, it is possible to spread the frequency spectrum without changing the ratio between the voltage vectors V0 and V7. Note that more specific means for realizing each function is disclosed in, for example, Japanese Patent Application Laid-open No. 2018-4246, and see the publication for reference.

As a first example in the third embodiment, while making the carrier signal a periodic function such as a sine wave or a triangular wave, the values of the carrier frequency Fc and the integer n are varied periodically or randomly so that the frequency Fh of the high-frequency voltage is constant in the above formula (5). With the use of this method, it is possible to, while generating the high-frequency voltage for heating the compressor 31, spread a spectrum of electromagnetic noise generated due to the carrier frequency Fc. Consequently, total noise in the compressor 31 can be reduced.

As a second example in the third embodiment, while making the high-frequency voltage a periodic function such as a sine wave or a triangular wave, the frequency Fh of the high-frequency voltage is varied periodically or randomly by setting the carrier frequency Fc to be constant and periodically or randomly varying the value of the integer n in the above formula (5). With the use of this method, it is possible to, while generating the high-frequency voltage for heating the compressor 31, spread a spectrum of mechanical noise due to the torque fluctuation of the motor 2 generated due to the frequency Fh of the high-frequency voltage.

In addition, as a third example in the third embodiment, the first and second examples are combined, and both the frequency Fh of the high-frequency voltage and the carrier frequency Fc are periodically or randomly varied. With the use of this method, it is possible to, while generating the high-frequency voltage for heating the compressor 31, spread both the spectrum of the electromagnetic noise generated due to the carrier frequency Fc and the spectrum of the mechanical noise due to the torque fluctuation of the motor 2 generated due to the frequency Fh of the high-frequency voltage.

As described above, according to the heat pump apparatus of the third embodiment, the drive signal generation unit performs control to set the frequency of the high-frequency voltage to be constant and to periodically or randomly change the carrier frequency. Consequently, the spectrum of the electromagnetic noise generated due to the carrier frequency can be spread, and total noise in the compressor 31 can be reduced.

In addition, according to the heat pump apparatus of the third embodiment, the drive signal generation unit performs control to set the carrier frequency to be constant and to periodically or randomly change the frequency of the high-frequency voltage. Consequently, the spectrum of the mechanical noise due to the torque fluctuation of the motor generated due to the frequency of the high-frequency voltage can be spread, and total noise in the compressor can be reduced.

Furthermore, according to the heat pump apparatus of the third embodiment, the drive signal generation unit performs control to periodically or randomly change each of the frequency of the high-frequency voltage and the carrier frequency, or performs control to periodically change any one of the frequency of the high-frequency voltage and the carrier frequency and randomly change the remaining other thereof. Consequently, both the spectrum of the electromagnetic noise generated due to the carrier frequency and the spectrum of the mechanical noise due to the torque fluctuation of the motor generated due to the frequency of the high-frequency voltage can be spread, and total noise in the compressor can be further reduced.

The configurations described in the above embodiments are merely examples and can be combined with other known technology, the embodiments can be combined with each other, and part of the configurations can be omitted or modified without departing from the gist thereof.

### REFERENCE SIGNS LIST

1 inverter; 2 motor; 3 direct-current power supply; 4, 4A, 4B inverter controller; 5, 5A, 5B drive signal generation unit; 7, 7A phase control unit; 8 voltage detector; 21a to 21f switching element; 30 refrigeration cycle; 31 compressor; 32 four-way valve; 33, 35 heat exchanger; 34 expansion mechanism; 36 refrigerant pipe; 37 compression mechanism; 41 processor; 42 memory; 53, 53A three-phase voltage command value generation unit; 53B spread spectrum voltage command value generation unit; 54, 54B PWM signal generation unit; 200, 200A, 200B heat pump apparatus.

1. A heat pump apparatus comprising:
an inverter comprising a plurality of switching elements and applying a high-frequency voltage to a motor that drives the compressor, the high-frequency voltage having a frequency higher than or equal to an operation frequency of the compressor;
a processor; and
a memory string a program which, when executed by the processor, performs processes of:
switching between positive and negative directions of an output voltage output from the inverter every half period of a carrier signal, the carrier signal being used for generating a switching signal, the switching signal controlling whether each of the switching elements is on or off, wherein
the processor sets, as a phase switching prohibition period, a time period of an integer multiple of two or more times the half period of the carrier signal, and prohibits switching between positive and negative directions of the output voltage in the phase switching prohibition period.

2. The heat pump apparatus according to claim 1, wherein
in a prohibition period in which switching between positive and negative directions of the output voltage is prohibited, an upper switching element in a leg of one phase or each leg of two phases among three phases of the inverter is controlled to be fixed to on or to be fixed to off, and a lower switching element of a leg to which the upper switching element belongs is controlled to be fixed to off or to be fixed to on.

3. The heat pump apparatus according to claim 1, wherein
a frequency of the high-frequency voltage and a carrier frequency that is a frequency of the carrier signal are not identical with each other.

4. The heat pump apparatus according to claim 3, wherein
a frequency of the high-frequency voltage is set to be constant, and the carrier frequency is periodically or randomly changed.

5. The heat pump apparatus according to claim 3, wherein
the carrier frequency is set to be constant, and a frequency of the high-frequency voltage is periodically or randomly changed.

6. The heat pump apparatus according to claim 3, wherein
a frequency of the high-frequency voltage and the carrier frequency are each periodically or randomly changed.

7. The heat pump apparatus according to claim 3, wherein
any one of a frequency of the high-frequency voltage and the carrier frequency is periodically changed, and a remaining other thereof is randomly changed.

8. (canceled)

9. The heat pump apparatus according to claim 1, wherein
a plurality of the switching elements are formed of a wide bandgap semiconductor.

10. The heat pump apparatus according to claim 9, wherein
the wide bandgap semiconductor is silicon carbide, gallium nitride, gallium oxide, or diamond.

11. An air conditioner comprising the heat pump apparatus according to claim 1.

12. A refrigeration machine comprising the heat pump apparatus according to claim 1.
